(19) United States
(12) Patent Application Publication
(10) Pub. No.: US 2017/0032638 A1
(43) Pub. Date: Feb. 2, 2017

(54) METHOD, APPARATUS, AND STORAGE MEDIUM FOR PROVIDING ALERT OF ABNORMAL VIDEO INFORMATION

(71) Applicant: Xiaomi Inc., Beijing (CN)

(72) Inventors: Yan Xie, Beijing (CN); Tian Ren, Beijing (CN); Yue Cheng, Beijing (CN); Da Wang, Beijing (CN)

(73) Assignee: Xiaomi Inc.

(21) Appl. No.: 15/156,948

(22) Filed: May 17, 2016

(30) Foreign Application Priority Data
Jul. 31, 2015 (CN) 201510461520.7

(51) Int. Cl. G08B 13/196; G06K 9/00

(52) U.S. Cl. CPC G08B 13/19615; G06K 9/00771; G06K 9/00255; G06K 9/00288; G08B 13/19656; G08B 13/19684

(57) ABSTRACT

A method for providing an alert of abnormal video information is provided. The method includes: acquiring video information; determining whether the video information includes an abnormal human face or a dangerous object; and if the video information includes the abnormal human face or the dangerous object, providing the alert indicating the abnormal video information.

### CROSS-REFERENCE TO RELATED APPLICATION

This application is based upon and claims priority of Chinese Patent Application No. 201510461520.7, filed on Jul. 31, 2015, which is incorporated herein by reference in its entirety.

### TECHNICAL FIELD

The present disclosure is related to the field of computer technology and, more particularly, to a method, an apparatus, and a storage medium for providing an alert of abnormal video information.

### BACKGROUND

Nowadays imaging devices (such as cameras and video recorders) are increasingly provided with communication modules for connecting to networks. User terminals may then establish communication connections with the imaging devices via networks and acquire video information captured by the imaging devices at remote locations.

### SUMMARY

According to a first aspect of the present disclosure, there is provided a method for providing an alert of abnormal video information, comprising: acquiring video information; determining whether the video information includes an abnormal human face or a dangerous object; and if the video information includes the abnormal human face or the dangerous object, providing the alert indicating the abnormal video information.

According to a second aspect of the present disclosure, there is provided an apparatus for providing an alert of abnormal video information, comprising: a processor; and a memory for storing instructions executable by the processor. The processor is configured to: acquire video information; determine whether the video information includes an abnormal human face or a dangerous object; and if the video information includes the abnormal human face or the dangerous object provide the alert indicating the abnormal video information.

According to a third aspect of the present disclosure, there is provided a non-transitory computer-readable storage medium having stored therein instructions that, when executed by a processor of a user terminal, causes the user terminal to perform a method for providing an alert of abnormal video information, the method comprising: acquiring video information; determining whether the video information includes an abnormal human face or a dangerous object; and if the video information includes the abnormal human face or the dangerous object, providing an alert indicating the abnormal video information.

It should be understood that both the foregoing general description and the following detailed description are exemplary and explanatory only and are not restrictive of the invention.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1A is a schematic diagram showing a system environment, according to an exemplary embodiment.

FIG. 1B is a schematic diagram showing a system environment, according to another exemplary embodiment.

FIG. 2 is a flowchart of a method for providing an alert of abnormal video information, according to an exemplary embodiment.

FIG. 3 is a flowchart of a method for providing an alert of abnormal video information, according to another exemplary embodiment.

FIGS. 4A-4C are schematic diagrams showing examples of providing an alert of abnormal video information, according to an exemplary embodiment.

FIGS. 5A-5C are schematic diagrams showing an example alert of abnormal video information, according to another exemplary embodiment.

FIG. 6 is a flowchart of a method for providing an alert of abnormal video information, according to another exemplary embodiment.

FIGS. 7A-7C are schematic diagrams showing an example alert of abnormal video information.

FIG. 8 is a flowchart of a method for providing an alert of abnormal video information, according to another exemplary embodiment.

FIG. 9 is a flowchart of a method for providing an alert of abnormal video information, according to another exemplary embodiment.

FIG. 10 is a flowchart of a method for providing an alert of abnormal video information, according to another exemplary embodiment.

FIG. 11 is a block diagram of an apparatus for providing an alert of abnormal video information, according to an exemplary embodiment.

FIG. 12 is a block diagram of an apparatus for providing an alert of abnormal video information, according to another exemplary embodiment.

FIG. 13 is a block diagram of apparatus for providing an alert of abnormal video information, according to another exemplary embodiment.

FIG. 14 is a block diagram of an apparatus for providing an alert of abnormal video information, according to another exemplary embodiment.

FIG. 15 is a block diagram of an apparatus for providing an alert of abnormal video information, according to another exemplary embodiment.

FIG. 16 is a block diagram of a device for providing an alert of abnormal video information, according to another exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise presented. The embodiments set forth in the following description of exemplary embodiments do not represent all embodiments consistent with the invention. Instead, they are merely examples of apparatuses and methods consistent with aspects related to the invention as recited in the appended claims.

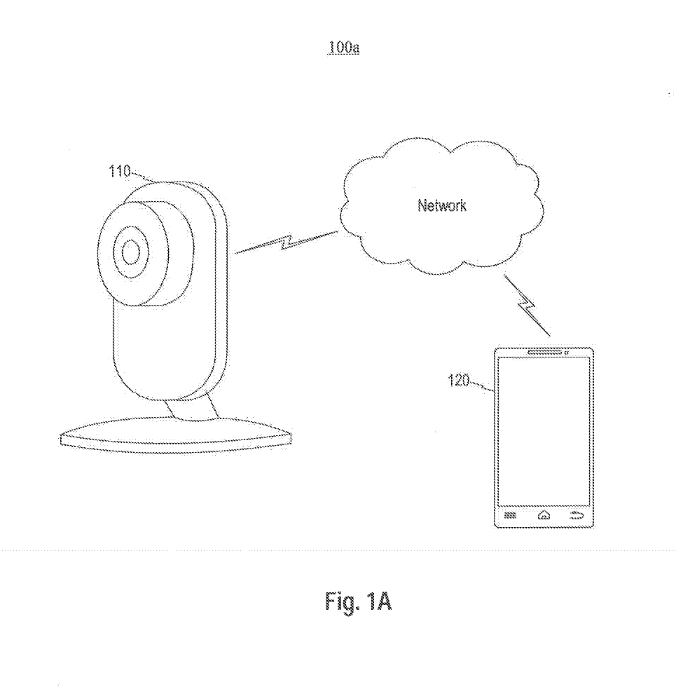

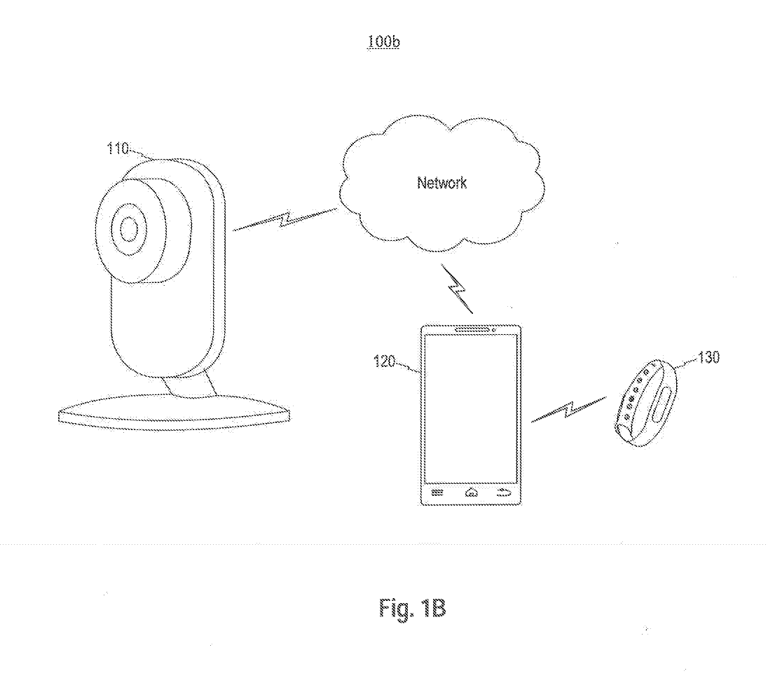

FIG. 1A is a schematic diagram showing a system environment 100a, according to an exemplary embodiment. Referring to FIG. 1A, the system environment 100a may include an imaging device 110 and a user terminal 120. The imaging device 110 in FIG. 1A is depicted as a smart camera. The imaging device 110 may be connected to and communicate with the user terminal 120 via a network such as WiFi, 2G, 3G and/or 4G networks.

The imaging device 110 may be a smart video recorder or a smart camera having storage and processing functions. In some embodiments, the imaging device 110 may include a camera connected to a server for storing and processing video information captured by the camera.

The user terminal 120 may be a smart cellphone, a tablet computer, a PC or a notebook computer or the like. The user terminal 120 in FIG. 1A is depicted as a smart phone. In some embodiments, the user terminal 120 may acquire video information captured by the imaging device 110 through a network, thereby performing remote video monitoring.

FIG. 1B is a schematic diagram showing a system environment 100b, according to another exemplary embodiment. Referring to FIG. 1B, the system environment 100b may include an imaging device 110, a user terminal 120, and a wearable device 130.

The imaging device 110 may be connected to and communicate with the user terminal 120 via a network such as WiFi, 2G, 3G and/or 4G networks.

The wearable device 130 may be a smart bracelet, a smart watch, a smart ring, smart gloves, smart clothes or the like, and may communicate with the user terminal 120. The wearable device 130 in FIG. 1B is depicted as a smart bracelet. An association relation may be established in advance between the wearable device 130 and the user terminal 120. The user terminal 120 may communicate with the wearable device 130 using wired or wireless communication technologies, such as Bluetooth, WiFi, or ZigBee. In some embodiments, the wearable device 130 and the user terminal 120 may be connected by low-power consumption Bluetooth technology to reduce the power consumption.

In some embodiments, the wearable device 130 may directly communicate with the imaging device 110 to acquire, store, and/or process video information captured by the imaging device 110.

In this disclosure, the wearable device 130 and the user terminal 120 may be referred to as user devices.

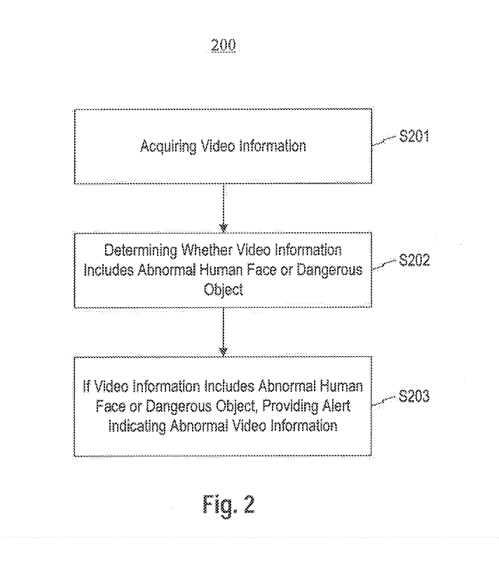

FIG. 2 is a flowchart of a method 200 for providing an alert of abnormal video information, according to an exemplary embodiment. The method 200 may be performed by a device, such as an imaging device, a user terminal, or a wearable device, described above in connection with FIGS. 1A and 1B. Referring to FIG. 2, the method 200 may include the following steps.

In Step S201, the Device Acquires Video Information.

For example, video information may be captured by the imaging device 110 shown in FIGS. 1A and 1B. When the device is a user terminal, the user terminal may acquire the video information from the imaging device that captures the video information. When the device is a wearable device, the wearable device may acquire the video information directly from the imaging device that captures the video information, or may acquire the video information via a user terminal connected to the wearable device. In some embodiments, the video information may be captured by the imaging device in real time such that the video information may be acquired in real time in step S201.

In step S202, the device determines whether the video information includes an abnormal human face or a dangerous object. For example, the abnormal human face may be defined by a user, and may include any human face or dangerous human face. The dangerous object may also be defined by the user, and may include a weapon or dangerous substance, such as a gun, ammunition, a dagger, fire and the like.

In step S203, if the video information includes an abnormal human face or a dangerous object, the device provides an alert indicating the abnormal video information. For example, a notification may be output by the user terminal and/or the wearable device described in FIGS. 1A and 1B. As another example, an alert message may be provided by the user terminal to the wearable device so as to alert the user about the abnormal video information.

In some embodiments, the device may be an imaging device, and the imaging device may provide an alert indicating the presence of abnormal video information. By providing an alert when abnormal people or dangerous objects appear in a video screen, the method 200 allows a user to promptly learn about the abnormal information.

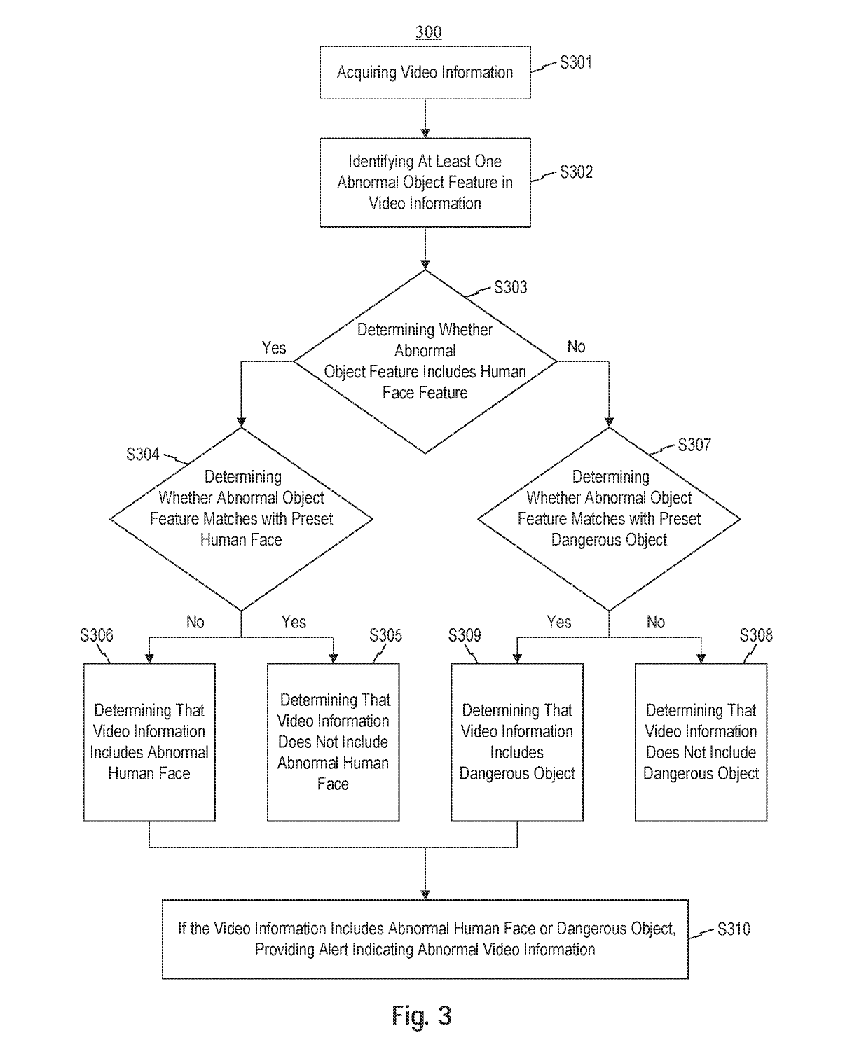

FIG. 3 is a flowchart of a method 300 for providing an alert of abnormal video information, according to another exemplary embodiment. The method 300 may be performed by a device, such as an imaging device (e.g., the imaging device 110 shown in FIGS. 1A-1B), a user terminal (e.g., the user terminal 120 shown in FIGS. 1A-1B), and/or a wearable device (e.g., the wearable device 130 shown in FIG. 1B). Referring to FIG. 3, the method 300 may include the following steps.

In step S301, the device acquires video information. The implementation of step S301 may be the same as that of step S201 described above in connection with FIG. 2.

In step S302, the device identifies at least one abnormal object feature in the video information. For example, the abnormal object feature may be identified using image feature extracting technologies. In this disclosure, abnormal objects may include human faces, dangerous objects, and/or other objects defined as non-conventional objects by the user.

In step S303, the device determines whether the abnormal object feature includes a human face. For example, the device may use face recognition technologies to determine whether the abnormal object feature includes a human face feature.

In step S304, if the abnormal object feature includes a human face feature, the device determines whether the abnormal object feature matches with a preset human face, where the preset human face represents a safe human face.

In step S305, if the abnormal object feature matches with the preset human face, the device determines that the video information does not include an abnormal human face.

In step S306, if the abnormal object feature does not match with the preset human face information, the device determines that the video information includes an abnormal human face.

In some embodiments, the preset human face may include one or more features associated with a safe human face. If the abnormal object feature matches with at least one feature of the preset human face, it may be determined that the video information does not include an abnormal human face. If the abnormal object feature does not match with any feature of the preset human face, it may be determined that the video information includes an abnormal human face.

In step S307, if the abnormal object feature does not include a human face feature, the device determines whether the abnormal object feature matches with a preset dangerous object.

In step S308, if the abnormal object feature does not match with the preset dangerous object, the device determines that the video information does not include a dangerous object.

In step S309, if the abnormal object feature matches with the preset dangerous object, the device determines that the video information includes a dangerous object.

For example, the preset dangerous object may include one or more features associated with a dangerous object. The dangerous object may include a gun, ammunition, a dagger, fire and the like. If the abnormal object feature matches with at least one feature of the preset dangerous object, it may be determined that the video information includes a dangerous object. If the abnormal object feature does not match with any feature of the preset dangerous object, it may be determined that the video information does not include a dangerous object.

In step S310, if the video information includes an abnormal human face or a dangerous object, the device provides an alert indicating the abnormal video information. The step S310 may be implemented the same as that of step S203 described above in connection with FIG. 2. By providing an alert when abnormal people or dangerous objects appear in a video screen, the method 300 allows a user to promptly learn about the abnormal information.

In some embodiments, if the video information does not include an abnormal human face or a dangerous object, the device may not provide any alert.

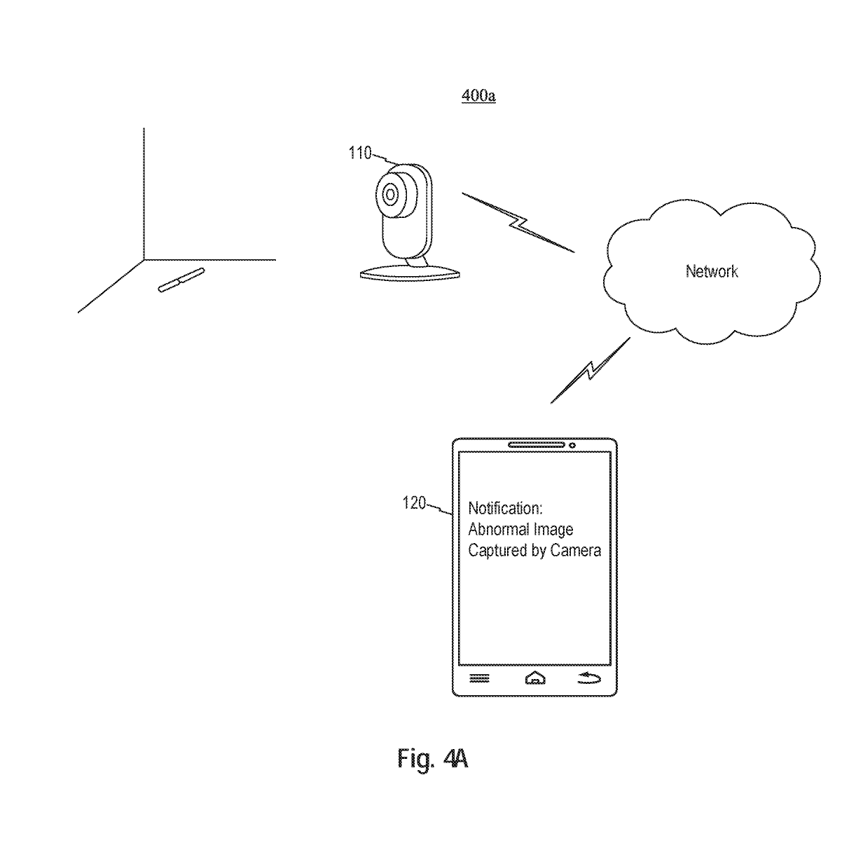

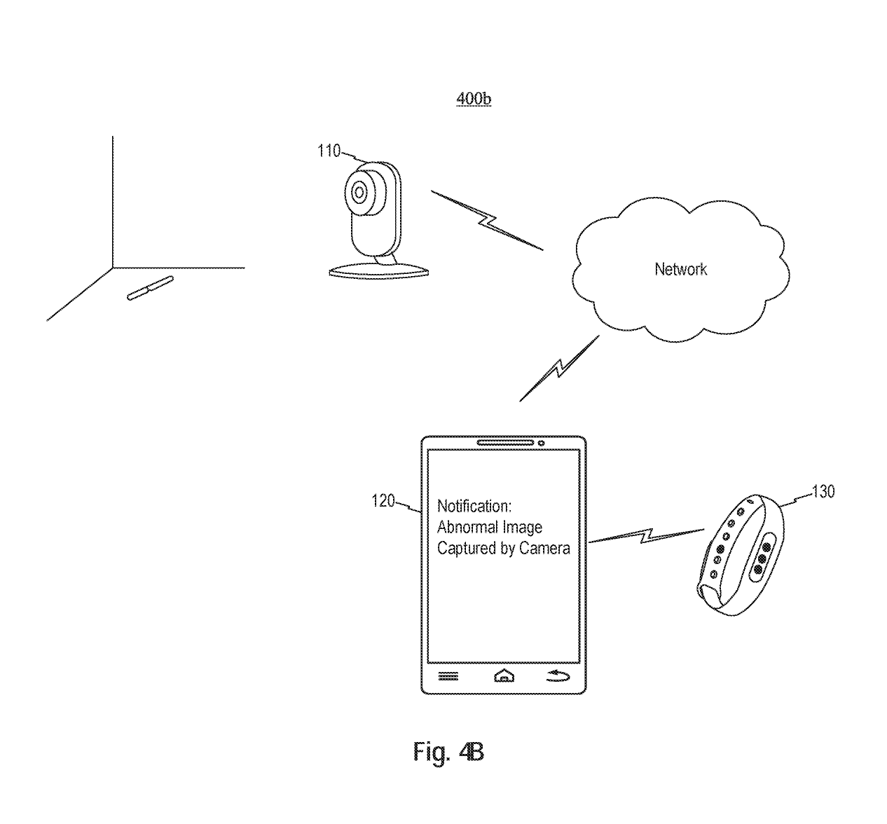

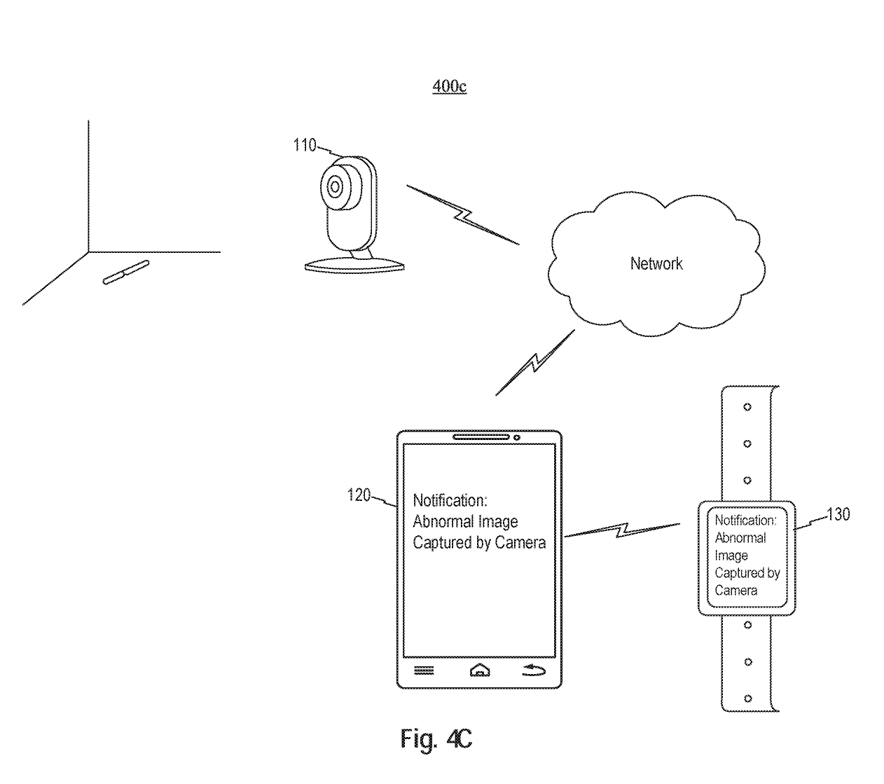

FIGS. 4A-4C are schematic diagrams 400a-400c showing an example alert of abnormal video information, according to an exemplary embodiment. As shown in FIG. 4A, when the video information captured by the imaging device 110 includes a dangerous object, such as a dagger, an alert of abnormality may be provided on a display screen of the user terminal 120. For example, a notification of “Abnormal Image Captured by Camera” may be displayed. In some embodiments, as shown in FIG. 4B or 4C, when the video information captured by the imaging device 110 includes a dangerous object, such as a dagger, a notification of abnormality may be provided on a display screen of the user terminal 120, and an alert may be provided to the wearable device 130. As shown in FIG. 4B, where the wearable device 130 does not include a display screen, an alert of abnormality may be provided by flashing a light of the wearable device. As shown in FIG. 4C, where the wearable device 130 includes a display screen, an alert of abnormality may be provided on a display screen of the wearable device 130. For example, a notification of “Abnormal Image Captured by Camera” may be displayed to inform the user about the abnormality.

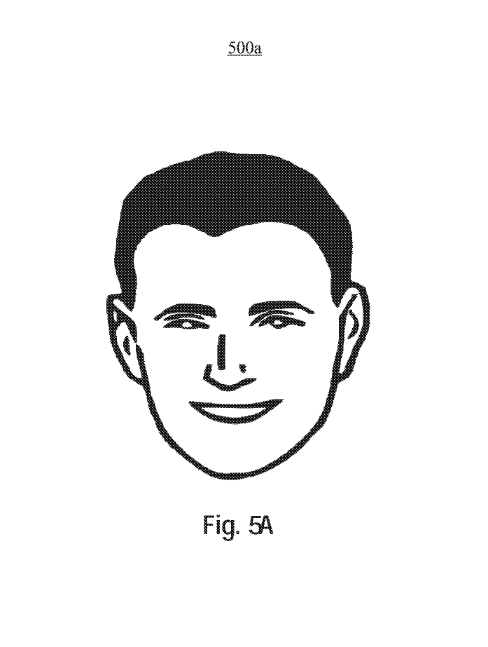

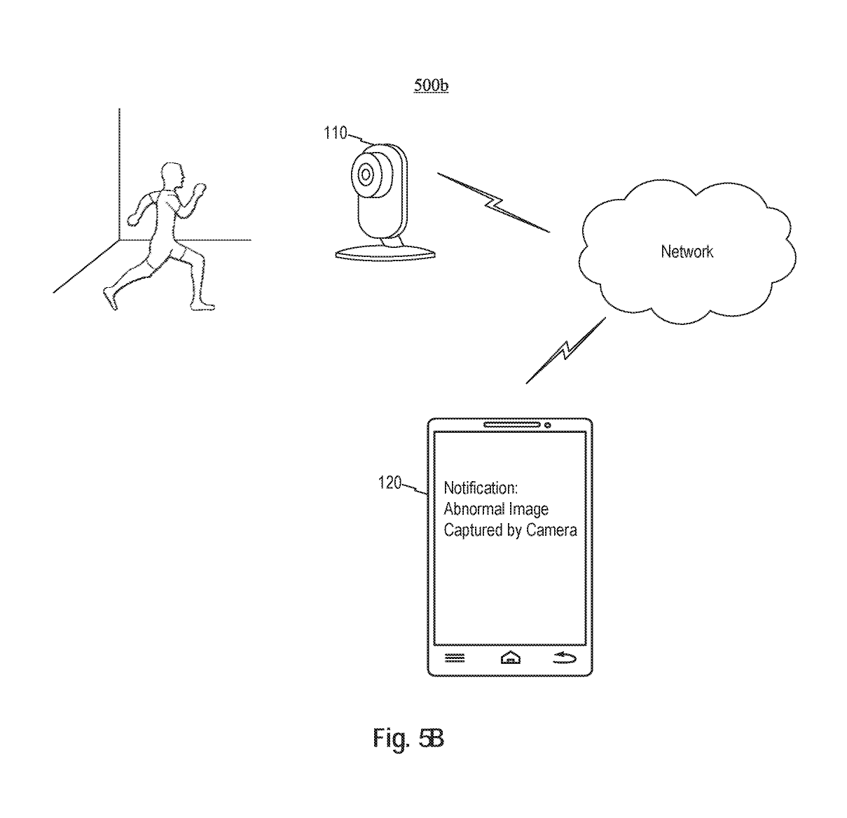

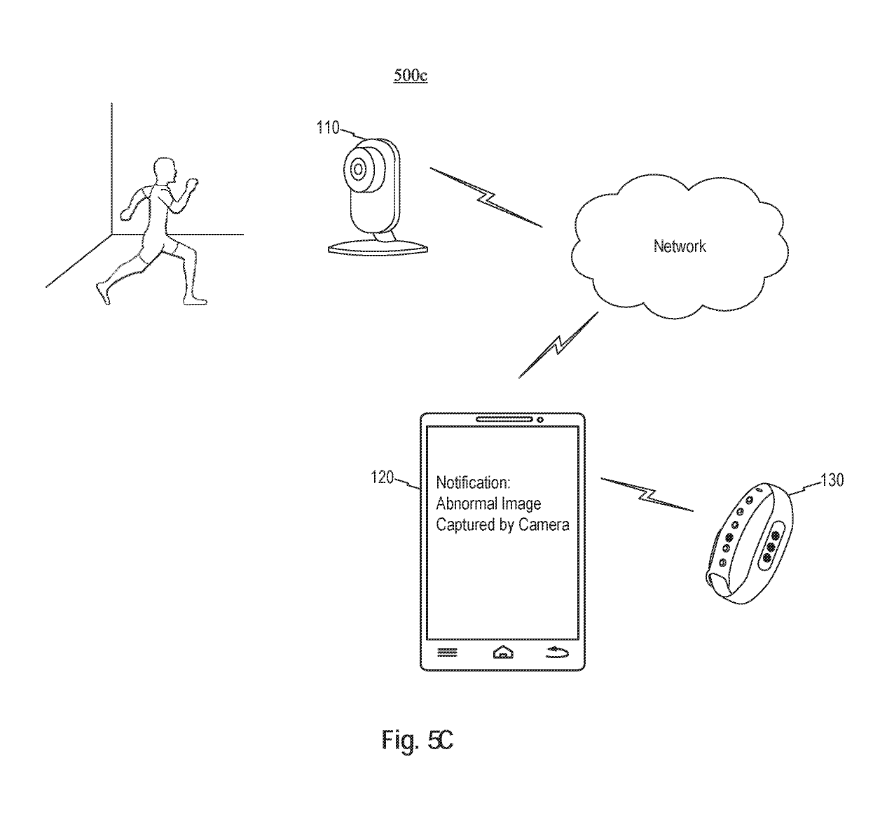

FIGS. SA-5C are schematic diagrams 500a-500c showing an example alert of abnormal video information, according to another exemplary embodiment. FIG. 5A illustrates a preset human face representing a safe human face. As shown in FIG. 5B, when the video information captured by the imaging device 110 includes an abnormal human face that does not match with the preset human face shown in FIG. 5A, an alert of abnormality may be provided on a display screen of the user terminal 120. For example, a notification of “Abnormal Image Captured by Camera” may be displayed. In some embodiments, as shown in FIG. 5C, when the video information captured by the imaging device 110 includes an abnormal human face that does not match with the preset human face shown in FIG. 5A, a notification of abnormality may be provided on a display screen of the user terminal 120, and an alert may be provided to the wearable device 130 indicating the abnormality. For example, the wearable device 130 may provide an alert of abnormality to a user by flashing a light.

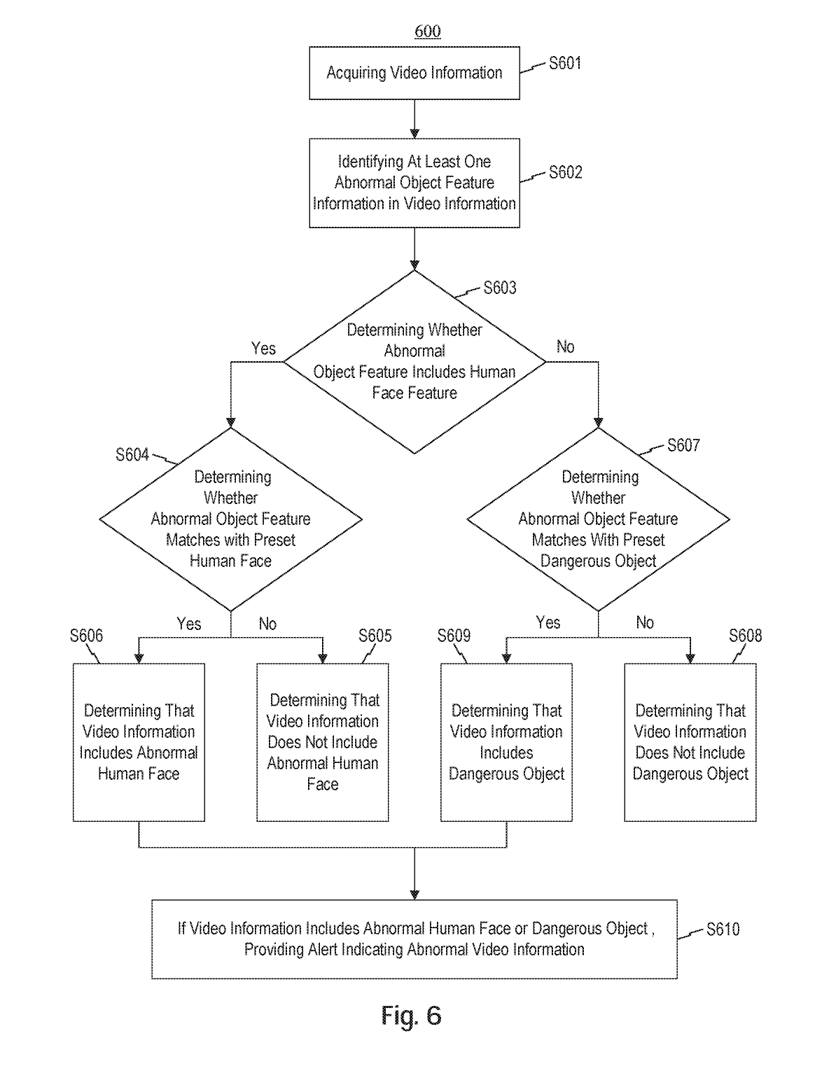

FIG. 6 is a flowchart of a method 600 for providing an alert of abnormal video information, according to another exemplary embodiment. The method 600 may be performed by a device, such as an imaging device (e.g., the imaging device 110 shown in FIGS. 1A-1B), a user terminal (e.g., the user terminal 120 shown in FIGS. 1A-1B), or a wearable device (e.g., the wearable device 130 shown in FIG. 1B). Referring to FIG. 6, the method 600 may include the following steps.

In step S601, the device acquires video information. The implementation of step S601 may be the same as that of step S201 described above in connection with FIG. 2.

In step S602, the device identifies at least one abnormal object feature in the video information.

In step S603, the device determines whether the abnormal object feature includes a human face feature. The implementation of steps S602-S603 may be the same as that of steps S302-S303 described above in connection with FIG. 3.

In step S604, if the abnormal object feature includes a human face feature, the device determines whether the abnormal object feature matches with a preset human face, where the preset human face represents a dangerous human face.

In step S605, if the abnormal object feature does not match with the preset human face, the device determines that the video information does not include an abnormal human face.

In step S606, if the abnormal object feature matches with the preset human face, the device determines that the video information includes an abnormal human face.

For example, the preset human face may include one or more human face features representing one or more dangerous human faces. If the abnormal object feature matches with any of the dangerous human faces, it may be determined that the video information includes an abnormal human face. If the abnormal object feature does not match with any of the dangerous human faces, it may be determined that the video information does not include an abnormal human face.

In step S607, if the abnormal object feature does not include a human face feature, the device determines whether the abnormal object feature matches with a preset dangerous object.

In step S608, if the abnormal object feature does not match with the preset dangerous object, the device determines that the video information does not include a dangerous object.

In step S609, if the abnormal object feature matches with the preset dangerous object, the device determines that the video information includes a dangerous object. The implementation of steps S607-S609 is the same as that of steps S307-S309 described above in connection with FIG. 3.

In step S610, if the video information includes an abnormal human face or a dangerous object, the device provides an alert indicating the abnormal video information. The step S610 may be implemented the same as that of step S203 described above in connection with FIG. 2. By providing an alert when abnormal people or dangerous objects appear in a video screen, the method 600 allows a user to promptly learn about the abnormal information.

In some embodiments, if the video information does not include an abnormal human face or a dangerous object, the device may not provide any alert.

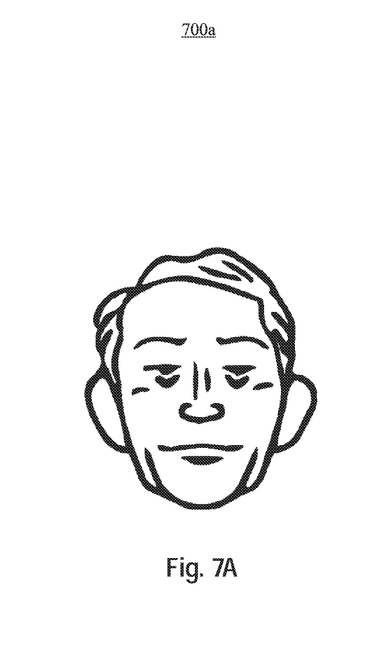

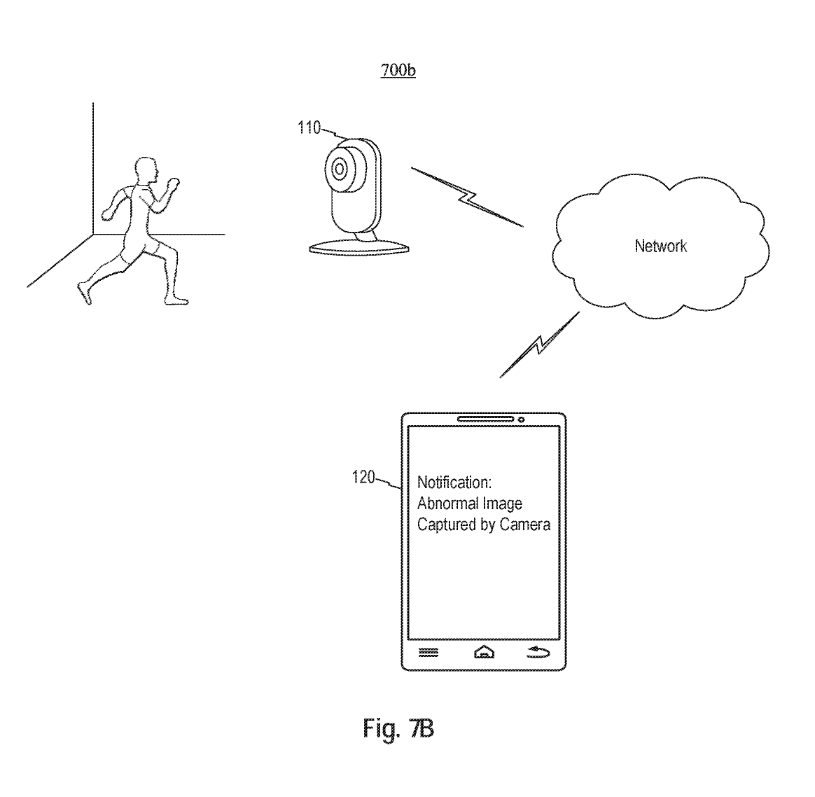

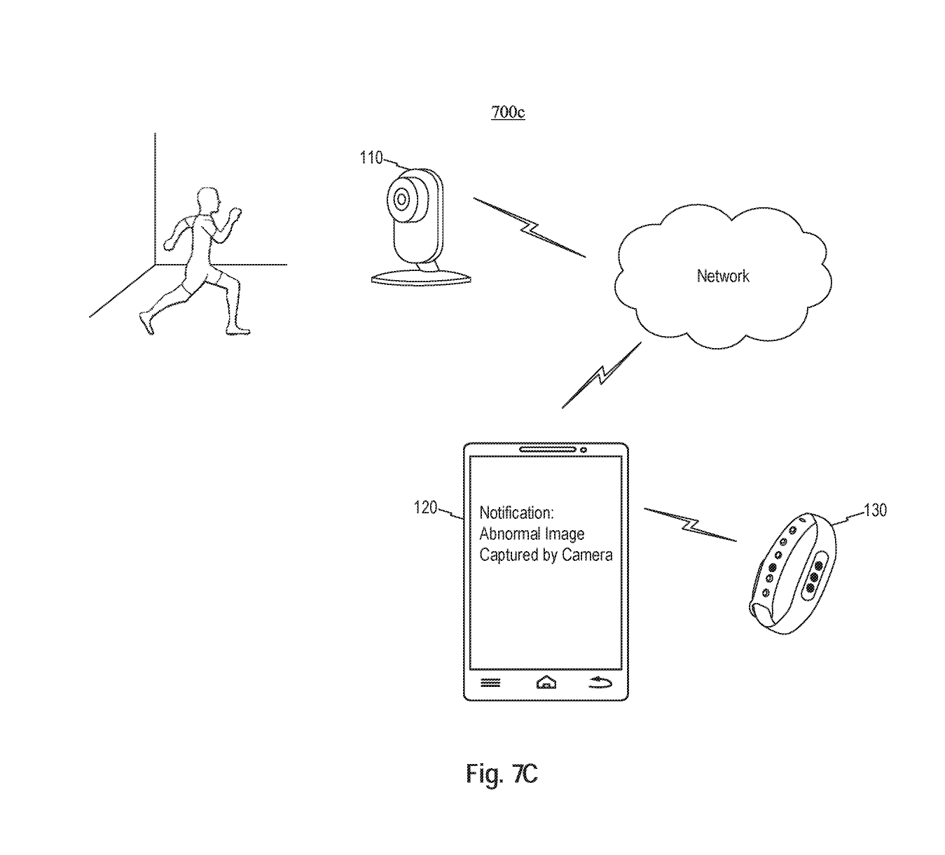

FIGS. 7A-7C are schematic diagrams showing examples of providing an alert of abnormal video information, according to another exemplary embodiment. FIG. 7A illustrates a preset human face representing a dangerous human face. As shown in FIG. 713, when the video information captured by the imaging device 110 includes an abnormal human face that matches with the preset human face shown in FIG. 7A, an alert of abnormality may be provided on a display screen of the user terminal 120. For example, a notification of “Abnormal Image Captured by Camera” may be displayed. In some embodiments, as shown in FIG. 7C, when the video information captured by the imaging device 110 includes an abnormal human face that matches with the preset human face shown in FIG. 7A, a notification of abnormality may be provided on a display screen of the user terminal 120, and an alert may be provided to the wearable device 130 indicating the abnormality. For example, the wearable device 130 may provide an alert of abnormality to a user by flashing a light.

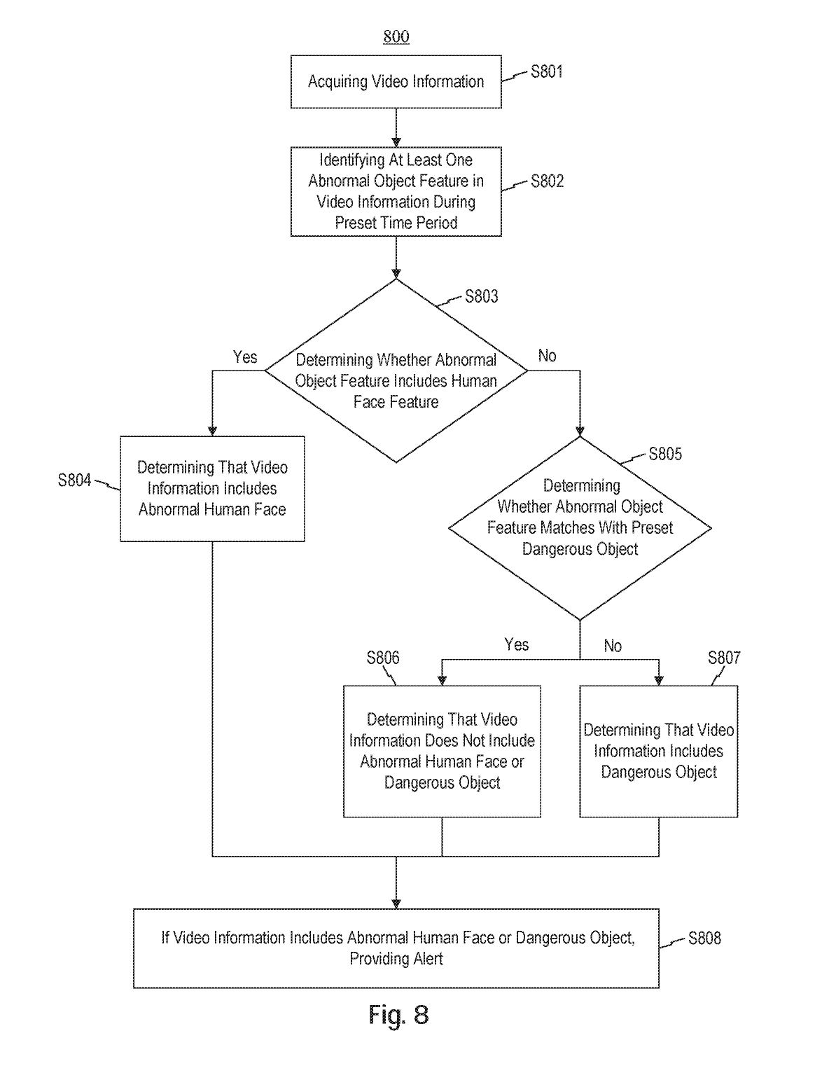

FIG. 8 is a flowchart of a method 800 for providing an alert of abnormal video information, according to another exemplary embodiment. The method 800 may be performed by a device, such as an imaging device (e.g., the imaging device 110 shown in FIGS. 1A-1B), a user terminal (e.g., the user terminal 120 shown in FIGS. 1A-1B), or a wearable device (e.g., the wearable device 130 shown in FIG. 1B). Referring to FIG. 8, the method 800 may include the following steps.

In step S801, the device acquires video information. The implementation of step S801 may be the same as that of step S201 described above in connection FIG. 2.

In step S802, the device identifies at least one abnormal object feature in the video information during a preset time period.

The preset time period may be pre-defined. For example, if the imaging device 110 is installed in at home for capturing video information in the home environment, the preset time period may be defined as a period during which the user is not at home, such as the work time (e.g., from 8:00 am to 19:00 pm). As such, an alert of abnormal video information may be provided only in that period.

In step S803, the device determines whether the abnormal object feature includes a human face feature. The implementation of step S803 is the same as that of step S303 described above in connection with FIG. 3.

In step S804, if the abnormal object feature includes a human face feature, the device determines that the video information includes an abnormal human face.

In step S805, if the abnormal object feature information does not include a human face feature, the device determines whether the abnormal object feature matches with a preset dangerous object.

In step S806, if the abnormal object feature does not match with the preset dangerous object, the device determines that the video information does not include an abnormal human face or a dangerous object.

In step S807, if the abnormal object feature matches with the preset dangerous object, the device determines that the video information includes a dangerous object.

In step S808, if the video information includes an abnormal human face or a dangerous object, the device provides an alert indicating the abnormal video information. The step S808 may be implemented the same as that of step S203 described above in connection with FIG. 2.

In the method 800, when the user is in the monitored area, an alert of abnormality may not be provided, thereby avoiding unnecessary alert and reducing power consumption of the device.

In some embodiments, if the video information does not include an abnormal human face or a dangerous object, the device may not provide any alert.

In some embodiments, the preset human face or dangerous object may be acquired from images captured by an imaging device, such as the imaging device 110 or a camera of the user terminal or the wearable device. For example, the user terminal may capture images of human faces or dangerous objects via a camera included in the user terminal. The user terminal may identify a human face from the images of human faces captured by the camera and set it as the preset human face. The user terminal may also identify a dangerous object from the images of dangerous objects captured by the camera and set it as the preset dangerous object.

In other embodiments, the preset human face or dangerous object may be acquired from images in an image library. The image library may be stored in the user terminal, the imaging device or the wearable device, and include at least one image. Candidate images may be selected from the existing images of the image library, and the preset human face or dangerous object may be identified from the candidate images. In doing so, dangerous objects, safe human faces, and/or dangerous human faces may be defined by users, thereby meeting needs of different users.

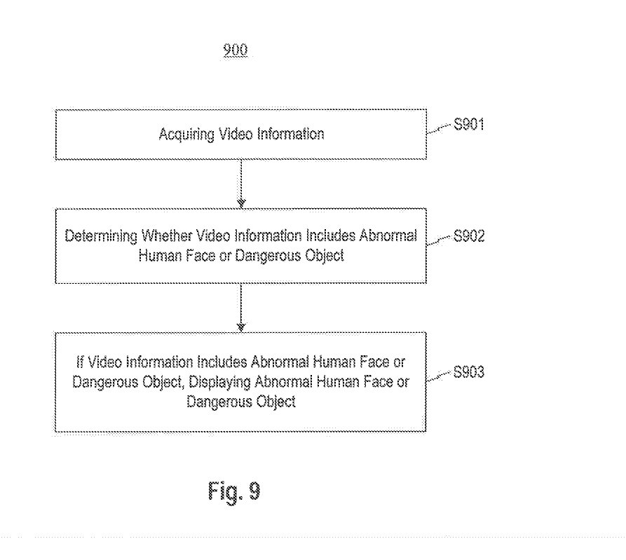

FIG. 9 is a flowchart of a method 900 for providing an alert of abnormal video information, according to another exemplary embodiment. The method 900 may be performed by a user device, such as a user terminal (e.g., the user terminal 120 shown in FIGS. 1A-1B), or a wearable device (e.g., the wearable device 130 shown in FIG. 1B). Referring to FIG. 9, the method 900 may include the following steps.

In step S901, the user device acquires video information.

In step S902, the user device determines whether the video information includes an abnormal human face or a dangerous object. The implementation of steps S901-S902 may be the same as that of steps S201-S202 described above in connection with FIG. 2.

In step S903, if the video information includes an abnormal human face or a dangerous object, the user device displays the abnormal human face or dangerous object included in the video information.

By displaying the abnormal human face or dangerous object, the user may be informed of the abnormal video information and learn about the conditions of the monitored areas promptly.

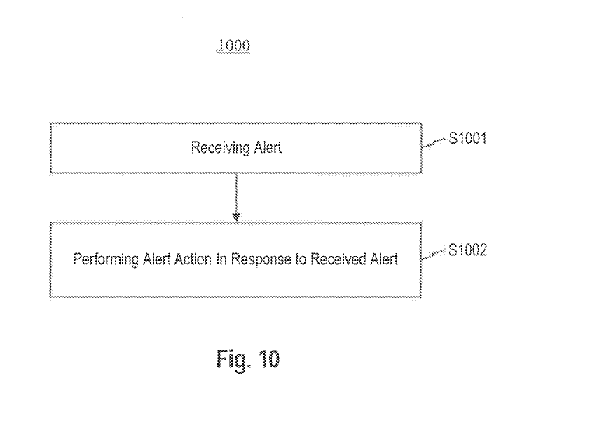

FIG. 10 is a flowchart of a method 1000 for providing an alert of abnormal video information, according to another exemplary embodiment. The method 1000 may be performed by a user device such as a user terminal (e.g., the user terminal 120 shown in FIGS. 1A-1B) and/or a wearable device (e.g., the wearable device 130 shown in FIG. 1B). Referring to FIG. 10, the method 1000 may include the following steps.

In step S1001, the user device receives an alert. For example, the alert may be generated by a user terminal or an image device according to the method 200, 300, 600, or 800, as described above.

In step S1002, the user device performs an alert action in response to the received alert. As such, when there is an abnormal or a dangerous object appears on a video screen, the method 1000 allows a user to promptly learn about the abnormal information via the user device.

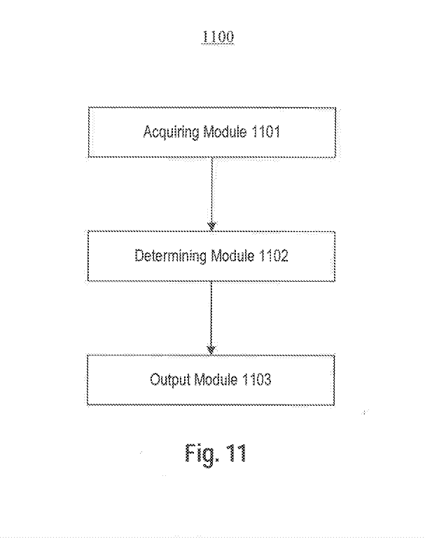

FIG. 11 is a block diagram of an apparatus 1100 for providing an alert of abnormal video information, according to an exemplary embodiment. Referring to FIG. 11, the apparatus 1100 may include an acquiring module 1101, a determining module 1102, and an output module 1103. The acquiring module 1101 may be configured to acquire video information. The determining module 1102 may be configured to determine whether the video information includes an abnormal human face or a dangerous object. The outputting module 1103 may be configured to provide an alert indicating abnormal video information, if the video information includes an abnormal human face or a dangerous object. In some embodiments, the video information may be captured by an imaging device in real time.

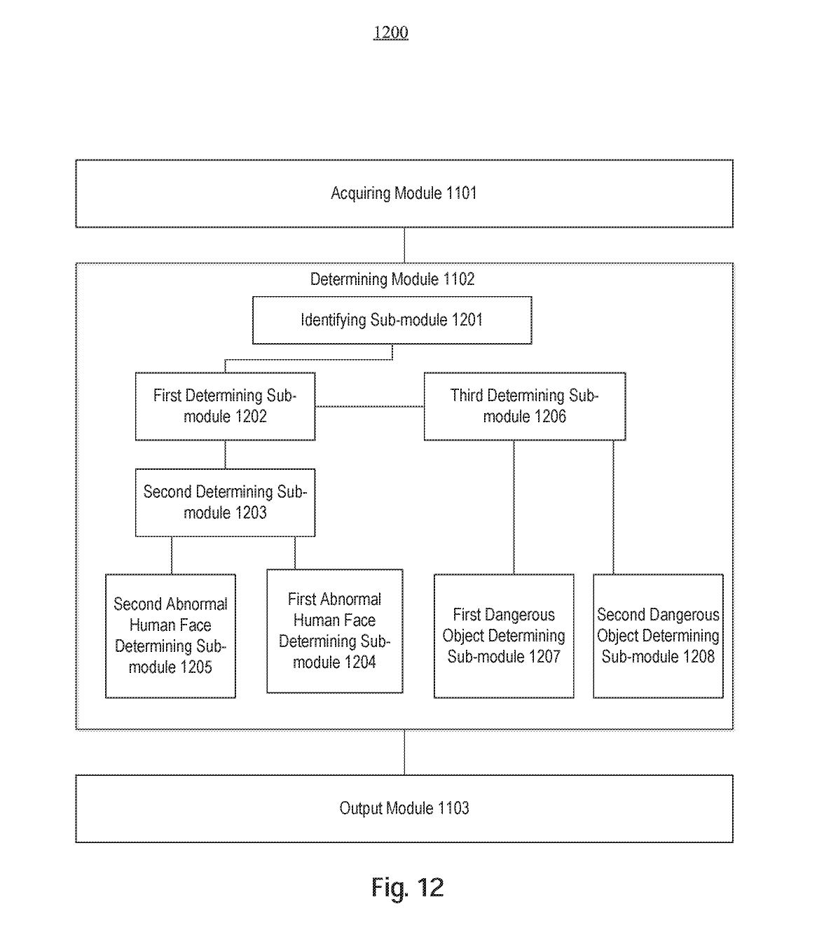

FIG. 12 is a block diagram of an apparatus 1200 for providing an alert of abnormal video information, according to another exemplary embodiment. Referring to FIG. 12, the apparatus 1200 may include an acquiring module 1101, a determining module 1102, and an output module 1103.

As shown in FIG. 12, the determining module 1102 may include an identifying sub-module 1201, a first determining sub-module 1202, a second determining sub-module 1203, a first abnormal human face determining sub-module 1204, a second abnormal human face determining sub-module 1205, a third determining sub-module 1206, a first dangerous object determining sub-module 1207, and a second dangerous object determining sub-module 1208.

The identifying sub-module 1201 may be configured to identify at least one abnormal object feature in the video information. The first determining sub-module 1202 may be configured to determine whether the abnormal object feature includes a human face feature. The second determining sub-module 1203 may be configured to determine whether the abnormal object feature matches with a preset human face when the abnormal object feature includes a human face feature, where the preset human face represents a safe human face. The first abnormal human face determining sub-module 1204 may be configured to determine that the video information does not include an abnormal human face if the abnormal object feature matches with the preset human face. The second abnormal human face determining sub-module 1205 may be configured to determine that the video information includes an abnormal human face, if the abnormal object feature does not match with the preset human face. The third determining sub-module 1206 may be configured to determine whether the abnormal object feature matches with a preset dangerous object when the abnormal object feature does not include a human face feature. The first dangerous object determining sub-module 1207 may be configured to determine that the video information does not include a dangerous object if the abnormal object feature does not match with the preset dangerous object. The second dangerous object determining sub-module 1208 may be configured to determine that the video information includes a dangerous object when the abnormal object feature matches with the preset dangerous object.

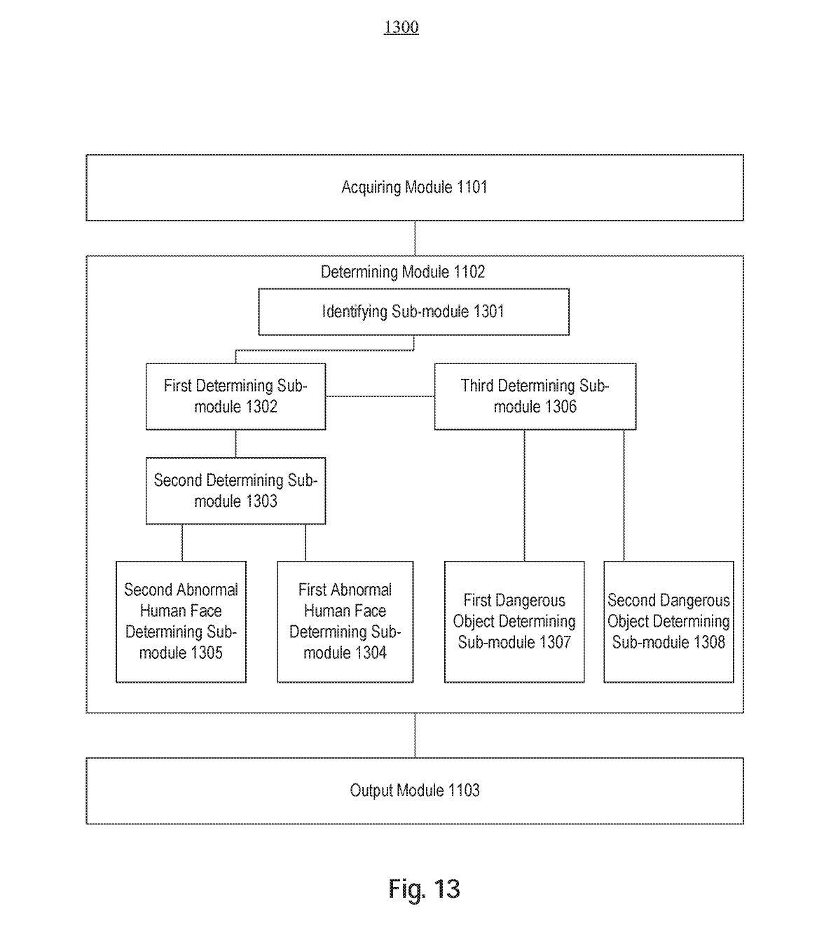

FIG. 13 is a block diagram of an apparatus 1300 for providing an alert of abnormal video information, according to another exemplary embodiment. Referring to FIG. 13, the apparatus 1300 may include an acquiring module 1101, a determining module 1102, and an output module 1103.

As shown in FIG. 13, the determining module 1102 may include an identifying sub-module 1301, a first determining sub-module 1302, a second determining sub-module 1303, a first abnormal human face determining sub-module 1304, a second abnormal human face determining sub-module 1305, a third determining sub-module 1306, a first dangerous object determining sub-module 1307, and a second dangerous object determining sub-module 1308.

The identifying sub-module 1301 may be configured to identify at least one abnormal object feature in the video information. The first determining sub-module 1302 may be configured to determine whether the abnormal object feature includes a human face feature. The second determining sub-module 1303 may be configured to determine whether the abnormal object feature matches with a preset human face when the abnormal object feature includes a human face feature, where the preset human face represents a dangerous human face. The first abnormal human face determining sub-module 1304 may be configured to determine that the video information does not include an abnormal human face if the abnormal object feature does not match with the preset human face. The second abnormal human face determining sub-module 1305 may be configured to determine that the video information includes an abnormal human face if the abnormal object feature matches with the preset human face. The third determining sub-module 1306 may be configured to determine whether the abnormal object feature matches with preset dangerous object when the abnormal object feature does not include a human face feature. The first dangerous object determining sub-module 1307 may be configured to determine that the video information does not include a dangerous object if the abnormal object feature does not match with the preset dangerous object. The second dangerous object determining sub-module 1308 may be configured to determine that the video information includes dangerous object if the abnormal object feature matches with the preset dangerous object.

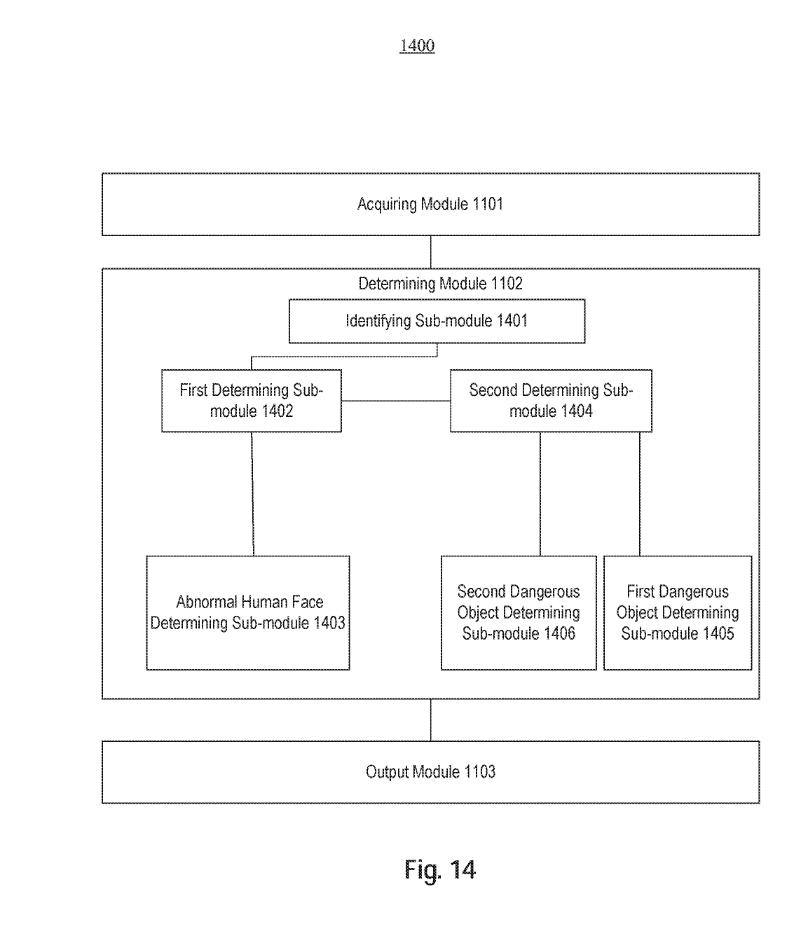

FIG. 14 is a block diagram of an apparatus 1400 for providing an alert of abnormal video information, according to another exemplary embodiment. Referring to FIG. 14, the apparatus 1400 may include an acquiring module 1101, a determining module 1102, and an output module 1103.

As shown in FIG. 14, the determining module 1102 may include an identifying sub-module 1401, a first determining sub-module 1402, an abnormal human face determining sub-module 1403, a second determining sub-module 1404, a first dangerous object determining sub-module 1405, and a second dangerous object determining sub-module 1406.

The identifying sub-module 1401 may be configured to identify at least one abnormal object feature in the video information during a preset time period. The first determining sub-module 1402 may be configured to determine whether the abnormal object feature includes a human face feature. The abnormal human face determining sub-module 1403 may be configured to determine whether the video information includes an abnormal human face, when the abnormal object feature includes a human face feature. The second determining sub-module 1404 may be configured to determine whether the abnormal object feature matches with a preset dangerous object, when the abnormal object feature does not include a human face feature. The first dangerous object determining sub-module 1405 may be configured to determine that the video information does not include an abnormal human face and a dangerous object if the abnormal object feature does not match with the preset dangerous object. The second dangerous object determining sub-module 1406 may be configured to determine that the video information includes a dangerous object if the abnormal object feature matches with the preset dangerous object.

In some embodiments, the preset human face or the preset dangerous object may be acquired from images captured by an image-capturing device. In other embodiments, the preset human face or the preset dangerous object may be acquired from images of an image library.

In some embodiments, the apparatus 1100-1400 shown in FIGS. 11-14 may be implemented as a part or all of an imaging device, a user terminal, (or a wearable device.

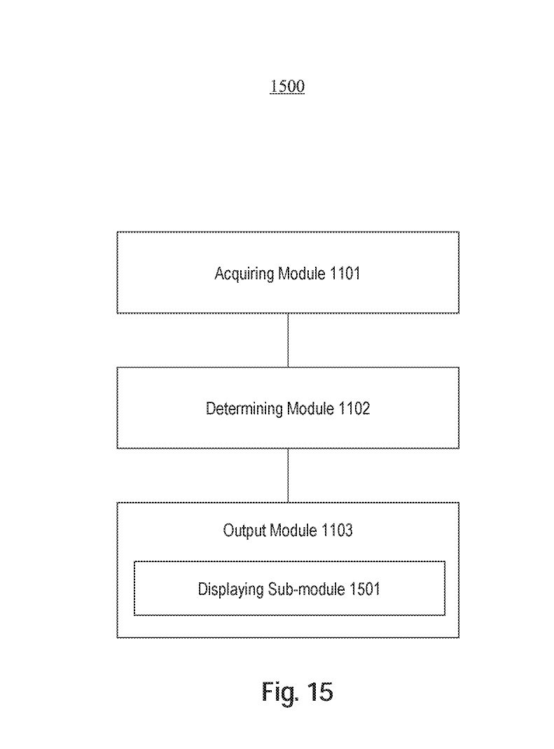

FIG. 15 is a block diagram of an apparatus 1500 for providing an alert of abnormal video information, according to another exemplary embodiment. Referring to FIG. 15, the apparatus 1500 may include an acquiring module 1101, a determining module 1102, and an output module 1103. As shown in FIG. 15, the output module 1103 may include a displaying sub-module 1501 configured to display the abnormal human face or dangerous object included in the video information.

In some embodiments, the apparatus 1500 may be implemented as a part or all of a user device such as a user terminal and/or a wearable device.

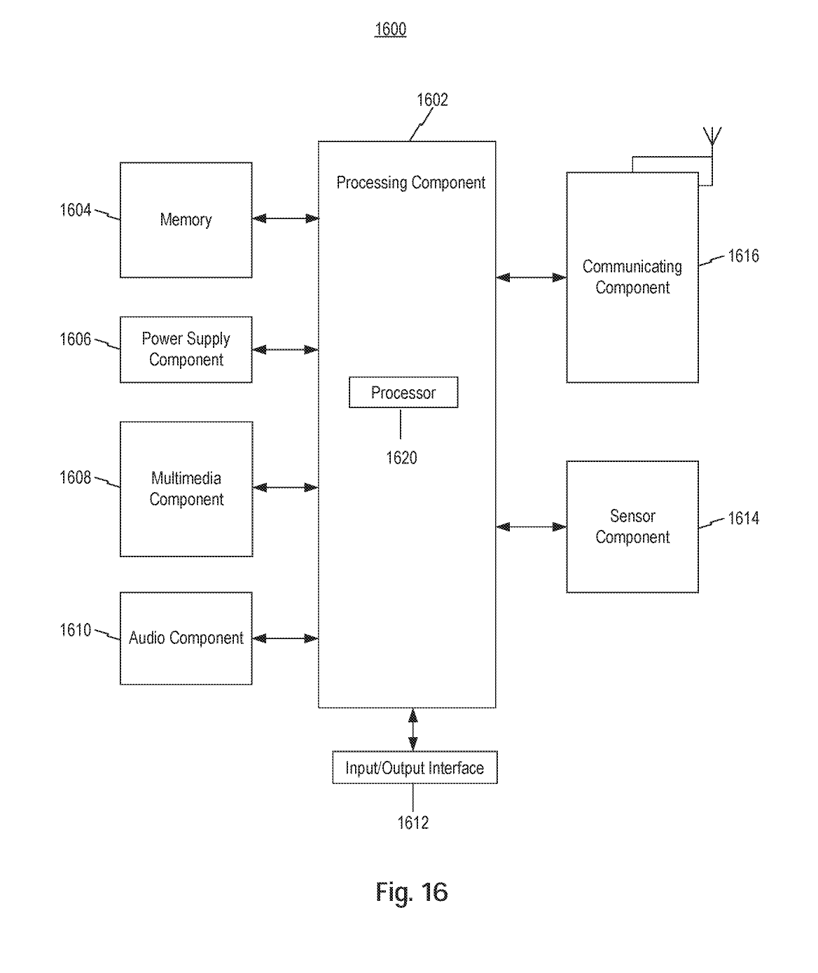

FIG. 16 is a block diagram of a device 1600 for providing an alert of abnormal video information, according to an exemplary embodiment. For example, the device 1600 may be an imaging device (such as a smart video recorder and a smart camera), a mobile phone, a computer, a digital broadcast terminal, a messaging device, a gaming console, a tablet device, a medical device, exercise equipment, a personal digital assistant (PDA), a wearable device (such as a smart bracelet and a smart watch) or the like.

Referring to FIG. 16, the device 1600 may include one or more of the following components: a processing component 1602, a memory 1604, a power supply component 1606, a multimedia component 1608, an audio component 1610, an input/output (I/O) interface 1612, a sensor component 1614, and a communication component 1616. The person skilled in the art should appreciate that the structure of the device 1600 as shown in FIG. 16 does not intend to limit the device 1600. The device 1600 may include more or less components or combine some components or other different components.

The processing component 1602 typically controls overall operations of the device 1600, such as the operations associated with display, telephone calls, data communications, camera operations, and recording operations. The processing component 1602 may include one or more processors 1620 to execute instructions to perform all or part of the steps in the above described methods. Moreover, the processing component 1602 may include one or more modules which facilitate the interaction between the processing component 1602 and other components. For instance, the processing component 1602 may include a multimedia module to facilitate the interaction between the multimedia component 1608 and the processing component 1602.

The memory 1604 is configured to store various types of data to support the operation of the device 1600. Examples of such data include instructions for any applications or methods operated on the device 1600, contact data, phonebook data, messages, images, video, etc. The memory 1604 is also configured to store programs and modules. The processing component 1602 performs various functions and data processing by operating programs and modules stored in the memory 1604. The memory 1604 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power supply component 1606 is configured to provide power to various components of the device 1600. The power supply component 1606 may include a power management system, one or more power sources, and any other components associated with the generation, management, and distribution of power in the device 1600.

The multimedia component 1608 includes a screen providing an output interface between the device 1600 and a user. In some embodiments, the screen may include a liquid crystal display (LCD) and/or a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 1608 includes a front camera and/or a rear camera. The front camera and the rear camera may receive an external multimedia datum while the device 1600 is in an operation mode, such as a photographing mode or a video mode. Each of the front camera and the rear camera may be a fixed optical lens system or have focus and optical zoom capability.

The audio component 1610 is configured to output and/or input audio signals. For example, the audio component 1610 includes a microphone configured to receive an external audio signal when the device 1600 is in an operation mode, such as a call mode, a recording mode, and a voice recognition mode. The received audio signal may be further stored in the memory 1604 or transmitted via the communication component 1616. In some embodiments, the audio component 1610 further includes a speaker to output audio signals.

The I/O interface 1612 provides an interface between the processing component 1602 and peripheral interface modules, such as a keyboard, a click wheel, buttons, and the like. The buttons may include, but are not limited to, a home button, a volume button, a starting button, and a locking button.

The sensor component 1614 includes one or more sensors to provide status assessments of various aspects of the device 1600. For instance, the sensor component 1614 may detect an on/off state of the device 1600, relative positioning of components, e.g., the display and the keypad, of the device 1600, a change in position of the device 1600 or a component of the device 1600, a presence or absence of user contact with the device 1600, an orientation or an acceleration/deceleration of the device 1600, and a change in temperature of the device 1600. The sensor component 1614 may include a proximity sensor configured to detect the presence of nearby objects without any physical contact. The sensor component 1614 may also include a light sensor, such as a CMOS or CCD image sensor, for use in imaging applications. In some embodiments, the sensor component 1614 may also include an accelerometer sensor, a gyroscope sensor, a magnetic sensor, a pressure sensor, or a temperature sensor.

The communication component 1616 is configured to facilitate communication, wired or wirelessly, between the device 1600 and other devices. The device 1600 can access a wireless network based on a communication standard, such as WiFi, 2G, or 3G, or a combination thereof. In one exemplary embodiment, the communication component 1616 receives a broadcast signal or broadcast associated information from an external broadcast management system via a broadcast channel. In one exemplary embodiment, the communication component 1616 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the device 1600 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the memory 1604, executable by the processor 1620 in the device 1600, for performing the above-described methods. For example, the non-transitory computer-readable storage medium may be a ROM, a RAM, a CD-ROM, a magnetic tape, a floppy disc, an optical data storage device, and the like.

It should be understood by those skilled in the art that the above described modules can each be implemented through hardware, or software, or a combination of hardware and software. One of ordinary skill in the art will also understand that multiple ones of the above described modules may be combined as one module, and each of the above described modules may be further divided into a plurality of sub-modules.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for providing an alert of abnormal video information, comprising:
acquiring video information;
determining whether the video information includes an abnormal human face or a dangerous object; and
if the video information includes the abnormal human face or the dangerous object, providing the alert indicating the abnormal video information.

2. The method according to claim 1, wherein the video information is captured by an imaging device in real time.

3. The method according to claim 1, wherein determining whether the video information includes the abnormal human face or the dangerous object comprises:
identifying at least one abnormal object feature in the video information;
determining whether the abnormal object feature includes a human face feature;
if the abnormal object feature includes a human face feature, determining whether the video information includes the abnormal human face based on a preset human face; and
if the abnormal object feature does not include a human face feature, determining whether the video information includes the dangerous object based on a preset dangerous object.

4. The method according to claim 3, wherein the preset human face represents a safe human face or a dangerous human face.

5. The method according to claim 3, wherein the abnormal object feature is identified during a preset time period.

6. The method according to claim 3, wherein the preset human face or the preset dangerous object is acquired from images captured by a capturing device or from images of an image library.

7. The method according to claim 3, wherein determining whether the video information includes the abnormal human face comprises determining whether the abnormal object feature matches with the preset human face.

8. The method according to claim 3, wherein determining whether the video information includes the dangerous object comprises determining whether the abnormal object feature matches with the preset dangerous object.

9. The method according to claim 1, wherein providing the alert comprises: displaying the abnormal human face or dangerous object.

10. A method for providing an alert of abnormal video information by a user device, comprising:
receiving the alert indicating the abnormal video information; and
performing an alert action in response to the alert, wherein the alert is generated by:
acquiring video information;
determining whether the video information includes an abnormal human face or a dangerous object; and
if the video information includes the abnormal human face or the dangerous object, providing the alert indicating the abnormal video information to the user device.

11. An apparatus for providing an alert of abnormal video information, comprising:
a processor; and
a memory storing instructions executable by the processor,
wherein the processor is configured to:
acquire video information;
determine whether the video information includes an abnormal human face or a dangerous object; and
if the video information includes the abnormal human face or the dangerous object provide the alert indicating the abnormal video information.

12. The apparatus according to claim 11, wherein the video information is captured by an imaging device in real time.

13. The apparatus according to claim 11, wherein the processor is further configured to:
identify at least one abnormal object feature in the video information;
determine whether the abnormal object feature includes a human face feature;
if the abnormal object feature includes the human face feature, determine whether the video information includes the abnormal human face based on a preset human face; and
if the abnormal object feature does not include the human face feature, determine whether the video information includes the dangerous object based on a preset dangerous object.

14. The apparatus according to claim 13, wherein the preset human face information represents a safe human face or a dangerous human face.

15. The apparatus according to claim 11, wherein the processor is configured to identify the abnormal object feature during a preset time period.

16. The apparatus according to claim 13, wherein the preset human face or the preset dangerous object is acquired from images captured by a capturing device or from images of an image library.

17. The apparatus according to claim 13, wherein the processor is further configured to determine whether the abnormal object feature matches with the preset human face.

18. The apparatus according to claim 13, wherein the processor is further configured to determine whether the abnormal object feature matches with the preset dangerous object.

19. The apparatus according to claim 11, wherein the processor is further configured to: display the abnormal human face or dangerous object.

20. A non-transitory computer-readable storage medium having stored therein instructions that, when executed by a processor of a user terminal, causes the user terminal to perform a method for providing an alert of abnormal video information, the method comprising:
acquiring video information;
determining whether the video information includes an abnormal human face or a dangerous object; and
if the video information includes the abnormal human face or the dangerous object, providing an alert indicating the abnormal video information.
